(19) United States
(12) Patent Application Publication
(10) Pub. No.: US 2009/0220101 A1
(43) Pub. Date: Sep. 3, 2009

(54) Method for the Active Reduction of Noise, and Device for Carrying Out Said Method

(76) Inventor: Harry Bachmann, Stäfa (CH)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/067,850

(22) PCT Filed: Sep. 15, 2006
(86) PCT No.: PCT/EP06/66408

§ 371 Date: Jul. 28, 2008

(30) Foreign Application Priority Data
Sep. 27, 2005 (CH) 1569/05

(51) Int. Cl. G10K 11/16

(52) U.S. Cl. 381/71.1

(57) ABSTRACT

Disclosed in a method in which a digital system is used for actively reducing noise. According to the method, a digital user signal can be transmitted at a different sampling rate, the sampling rate being adjusted with the aid of adequate converters.

### RELATED APPLICATION

This application is a U.S. national phase application under 35 U.S.C. §371 of International Application No. PCT/EP2006/066408 filed Sep. 15, 2006, which claims priority of Switzerland Application No. 1569/05 filed Sep. 27, 2005.

### TECHNICAL FIELD

The present invention is related to a method for active noise reduction, as well as to a device to implement the method, in which an input signal is fed to an unknown transfer function, the unknown transfer function or its actual output signal being estimated with the aid of an adaptive process by using the input signal and an error signal corresponding to the difference between an estimated output signal and the actual output signal, and the estimated output signal being subtracted from the actual output signal to form a noise reduced output signal.

### BACKGROUND AND SUMMARY

Noise sources are increasingly perceived as environmental pollution and are considered to be a diminution of quality of life. As noise sources frequently cannot be avoided, methods for noise reduction based on the principle of interference were already suggested.

The principle for active noise reduction (ANC or “Active Noise Cancelling”) is based on the cancellation of sound waves by interferences. These interferences are generated by one or several electro-acoustic converters, for example by loudspeakers. The signal emitted from the electro-acoustic converters is calculated using an appropriate algorithm suitable for that purpose and corrected continuously. Information provided from one or several sensors serve as basis for the calculation of the signals to be emitted from the electro-acoustic converters. This is on the one hand information about the character of the signal to be minimized. For this, a microphone, for example, can be used for capturing the sound to be minimized. On the other hand, information about the remaining residual signal is also needed. For this, microphones can also be used.

A known implementation to reduce noises actively, are headphones used by helicopter pilots, for example. Thus, noises getting into headphones of helicopter pilots are actively attenuated by exploiting knowledge of noises derived from the drive of the rotors. The signal processing by these known headphones is implemented with the aid of analogue technology, e.g. the acoustic signals and their processing is carried out analogously only.

For the known headphones, it is possible to superimpose a desired signal, as for example radio communication, since both signals are analogue.

All analogue implementations have in common that they are optimized for a specific situation. A transfer to other implementations is generally not easy to accomplish. Therefore, a new conception of the hardware is always necessary if solutions for new implementations must be provided.

It is therefore the object of the present invention to provide a method for active noise reduction, which does not have the above-mentioned drawbacks.

This object is obtained by the features disclosed herein wherein a desired signal is superimposed on the noise reduced output signal, the desired signal not affecting the error signal, and wherein a computation cycle of the adoptive process is longer than a clock interval of the desired signal. Advantageous embodiments of the present invention as well as a device to implement the method are described below.

The present invention is used for active noise reduction in an input signal, which is processed by an unknown transfer function. Now the method consists in that the unknown transfer function or its actual output signal, respectively, is estimated with the aid of an adaptive process using the input signal and an error signal. In doing so, the error signal corresponds to the difference between the estimated output signal and the actual output signal. Further, the estimated output signal is subtracted from the actual output signal in order to form a noise reduced output signal. The invention is characterized in that a desired signal is superimposed on the noise reduced output signal, whereas the desired signal does not influence the error signal and that a computation cycle of the adaptive process is longer than a clock interval of the desired signal.

Thereby, a flexible method is created, which can be transferred to a new implementation very quickly. In particular, the hardware used for this purpose must not be modified, but an adjustment of the algorithms needed, controlling the adaptive process, is sufficient. Furthermore, the fact is taken into account that an active noise reduction requires a high computational power.

Meanwhile the requirements for the computational power are so high that the input signals to be processed must have a relatively low sampling rate. Input signals with too high sampling rates are hence not processable. That is why high sampling rates are also not appropriate, because an active noise reduction functions steadily in particular at relatively low frequencies.

In one embodiment of the present invention, it is provided that a clock interval of the input signal is adapted to the computation cycle of the adaptive process and that the clock interval of the estimated output signal is adapted to the clock interval of the desired signal.

Thereby the fact is further taken into account that, due to the available computation power, a reduced processing cycle is required for the adaptive process. In connection with the terms “clock interval” and “computation cycle”, it is pointed out that its reciprocal values correspond to the respective sampling rates.

A further embodiment of the present invention consists in that the adjustment of the clock interval of the input signal is carried out with the help of a decimation algorithm, and, in yet another embodiment, that the adjustment of the clock interval of the estimated output signal is carried out with the help of an interpolation algorithm.

Decimation algorithms as well as interpolation algorithms for modifying the sampling rates of digital signals are described, for example, by Ronald E. Crochiere and Lawrence R. Rabiner in the publication entitled “Multirate Digital Signal Processing” (Prentice Hall, Inc., Englewood Cliffs, N.J., 1983)

Moreover a further embodiment is characterized in that a time delay difference existing between the desired signal and the noise reduced output signal is corrected with the help of an adaptive delay unit.

Beside the method according to the present invention, a device with an input signal is also disclosed that is fed to an unknown transfer function having an actual output signal. In addition, the device comprises:
an adaptive processor unit, to which the input signal is impinged on and that comprises an estimated output signal,
means for generating a signal error from the estimated output signal and the actual output signal and
means for generating a noise reduced output signal, the error signal being impinged on the adaptive processor unit. In addition, the device comprises:
a desired signal source for generating a desired signal, and
means for superimposing the desired signal on the noise reduced output signal, a computation cycle of the adaptive processor unit being longer than a clock signal of the desired signal.

A further embodiment of the present invention comprises:
means for adjusting the sampling interval of the input signal to the computing cycle of the adaptive processor unit and
means for adjusting a sampling interval of the estimated output signal to a sampling interval of the desired signal.

A further embodiment of the present invention consists in that the means for generating a noise reduced output signal is at least one loudspeaker unit, to which the actual output signal and the estimated output signal are impinged on.

Moreover, it is provided in a further embodiment of the present invention that the desired signal is additionally impinged on at least one loudspeaker unit.

A still further embodiment of the device according to the present invention consists in that the input signal is impinged on the means for adjusting the sampling interval of the input signal to the computing cycle of the adaptive processor unit via of an analog-to-digital converter unit and that the estimated output signal is impinged on the means for generating a noise reduced output signal via a digital-to-analog converter unit.

Finally a further embodiment consists in that a first filter unit is arranged previous to the mean for adjusting the sampling interval of the input signal on the computing cycle of the adaptive process unit.

In the following, the present invention is described by referring to drawings, which show exemplified embodiments of the present invention

### BRIEF DESCRIPTION OF DRAWINGS

FIG. 1 schematically, a block diagram of a device according to the present invention,

FIG. 2 again schematically, a block diagram of a further embodiment, and

FIG. 3 a modified part compared with the block diagrams according to FIGS. 1 and 2.

### DETAILED DESCRIPTION

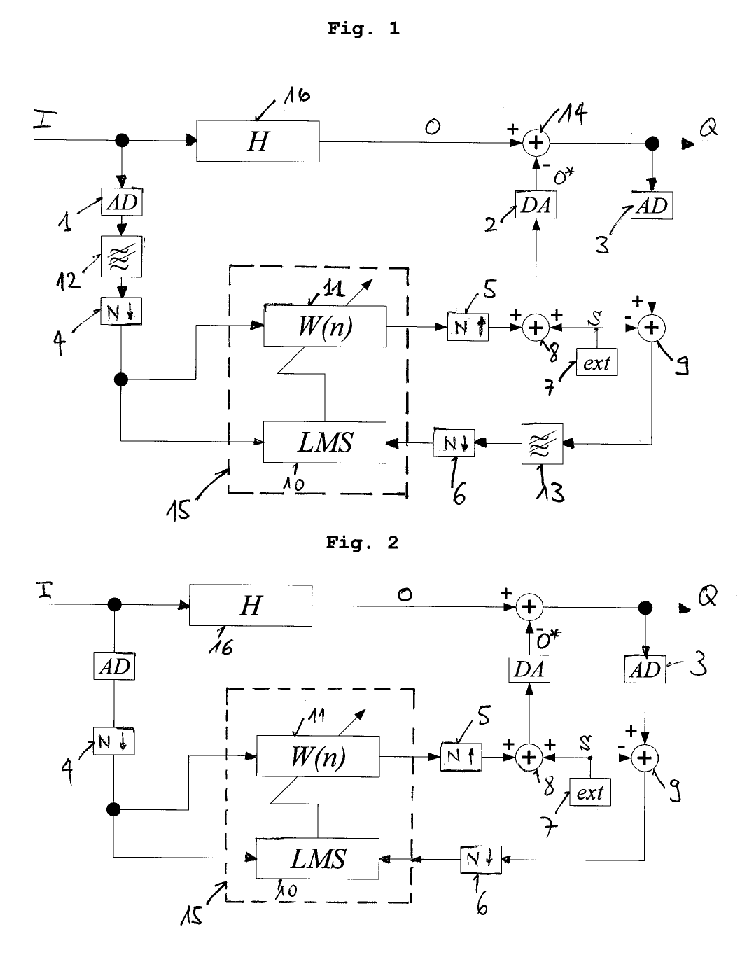

FIG. 1 shows a block diagram of a device according to the present invention—including transfer function H—for active noise reduction (“active noise canceller”—ANC), whereas the possibility is given to superimpose a desired signal S generated in a external desired signal source 7.

The transfer function H is first of all an unknown quantity, which is estimated in an adaptive processor unit 15. Alternatively an actual output signal 0 of the transfer function H is estimated in the adaptive process unit 15. The transfer function H is used for explaining the device according to the present invention or the method according to the present invention, respectively, and is itself not part of the method according to the present invention or the device according to the present invention, respectively. The transfer function H describes an actual output signal 0 originating as a result of an input signal I fed to the transfer function H. Relating to the implementation in a helicopter mentioned in the introductory part of the description, the input signal I corresponds to the sound of the helicopter, as it can be found in a cockpit, for example, and the actual output signal 0 corresponds to the acoustic signal, as it still is present in the headphones. Accordingly, the transfer function H describes the alteration of the input signal I through the shell of the headphones. Now an active noise reduction is achieved thereby that the transfer function H or its output signal, respectively, is estimated. Thereto, the input signal I is fed to an adaptive processor unit 15 via an analog-to-digital converter unit 1, via a first filter unit 12 and via a first decimation unit 4, as depicted in FIG. 1. In the adaptive processor unit 15, an estimated output signal 0* is determined by using an adaptive algorithm, which estimated output signal 0* is fed to an interpolation unit 5. In the interpolation unit 5, a sampling rate is adjusted, which corresponds to the desired signal S. Thereby, the condition is met that the estimated output signal 0* and the desired signal S can be added, which occurs in the addition unit 8 by impinging the estimated output signal 0* as well as the desired signal S to the addition unit 8. The output signal of the addition unit 8 is fed into a superposition unit 14 via a digital-to-analog converter unit 2, to which superposition unit 14 the actual output signal 0 is fed as well, the estimated output signal 0* being inverted previous to the superposition, i.e. previous to the superimposing with the actual output signal 0, so that a match of the two signals results in a cancellation of the signal, i.e. the estimated output signal 0* cancels the actual output signal 0 completely. In case no match of the two signals given takes place, thus no cancellation of the signal occurs but a reduction corresponding to the degree of the match.

It is pointed out that die superposition unit 14 has to be considered as a part of a model, which describes the situation—again in relation to the example of the helicopter—in the space described by the auricle. In fact, the estimated output signal Q* is transmitted to one, where appropriate to several earphone units (not depicted in FIG. 1) for generating an acoustic signal. The cancellation (for a complete match of the actual and the estimated output signal) or the signal reduction (at still different signals), respectively, occurs in the closed space.

In order that the adaptive processor unit 15 or the computation carried out in there, respectively, can be adjusted continuously to the possibly changing transfer function H, an error signal ε is fed back to the adaptive processor unit 15. Therein the estimated signal 0* or the transfer function estimated in the adaptive processor unit 15, respectively, is optimized as long as the error signal ε has reached a minimum.

According to the present invention, a desired signal S is superimposed on a noise reduced output signal Q. This must be taken into account while calculating the error signal ε. This is accomplished by a subtraction unit 9, to which, on the one hand the desired signal S of the desired signal source 7, and on the other hand the converted noise reduced output signal Q, are fed that is recorded by a microphone, for example, (not depicted in FIG. 1) and converted by a second analog-to-digital converter unit 3. As a consequence of the superimposing of the desired signal S and the estimated output signal 0* in order to form the actual output signal 0, the desired signal S must be subtracted to generate the error signal ε. This subtraction occurs in the subtraction unit 9 as described above. As the digital-to-analog converter unit 2 and the analog-to-digital converter unit 3 are operated at the same sampling rate, the output signal of the subtraction unit 9 corresponding to the error signal ε has to be adjusted to the adaptive processor unit 15 to its computing cycle before a transfer.

Thereto a second decimation unit 6 is provided to carry out the required adjustment in the sampling rates or in the sampling intervals, respectively.

In order that so-called antialiasing effects can be avoided, a first and/or a second filter unit 12, 13 is provided previous to the first decimation unit 4 and/or previous to the second decimation unit 6 in the embodiment according to FIG. 1.

An adaptive processor unit 15 is depicted in dashed lines in FIG. 1. Two components of the adaptive processor unit 15 are depicted inside of the frame having dashed lines, whereby an adjustable transfer function W and an error computing unit LMS operatively connected to it are present. Ideally, the adjustable transfer function W corresponds to the transfer function H. Only then, the estimated output signal 0* corresponds to the actual output signal 0, and a complete signal cancellation is the result. In case of dissimilarity, a correspondingly reduced signal cancellation or merely a signal reduction, respectively, results. The error computing unit LMS affects the adjustable transfer function W in such a manner that a signal reduction as great as possible or even a complete signal cancellation, respectively, is obtained. For this, a so-called LMS (Least Mean Square) algorithm is suitable, the LMS-algorithm being one of many other possible implementations. Basically, the algorithms known from the adaptive signal processing for determination of the estimated output signal are applicable in the adaptive processor unit, as they are described by Ronald F. Crochiere and Lawrence R. Rabiner in the publication entitled “Multirate for example Digital Signal Processing” (Prentice Hall, Inc., Englewood Cliffs, N.J., 1983), for example.

It has already been pointed out that the two analog-to-digital converter units 1 and 3 convert a analog signal recorded by a microphone, for example, (not depicted in FIG. 1) into corresponding digital signals. Furthermore, a calculated digital signal, namely the estimated output signal 0*, is converted by the digital-to-analog converter unit 2 to an analog signal, which is impinged on a loudspeaker, for example (not depicted in FIG. 1). As the converter units 1, 2 and 3 belong to the same CODEC, they are run with identical sampling rate.

The CODEC must run with a high sampling rate, as soon as the desired signal S has to fullfill corresponding qualitative requirements, as it is given in the case of music, for example. For CD quality, the sampling rate is 44.1 kHz. As a consequence, the converter units 1 to 3 have to be run at this clock frequency of 44.1 kHz. However in the adaptive processor unit 15 the algorithm used runs at substantially lower frequencies, for example at 8 kHz. This conversion is, as mentioned, carried out by the decimation units 4 and 6. The interpolation unit 5 converts the output signal estimated by the adaptive processor unit 15, the estimated output signal having a sampling rate of 8 kHz, into a sampling rate of 44.1 kHz that is needed for the reproduction of music.

Thereby, the signals fed into the addition unit 8 and the subtraction unit 9 have an identical sampling rate. As a consequence thereof, the signals can be added or subtracted, respectively, without difficulty.

FIG. 1 shows an embodiment of the present invention by which antialiasing effects are avoided.

For this, filter units 12 and 13 are provided, as already mentioned, previous to the decimation units 4, respectively 6. The two filter units 12 and 13 now make sure that the subsequent decimation units 4 and 6 only incorporate relevant signal parts by filtering out all signal parts above the half of the reduced sampling rate, thus in this case, all signal parts above 4 kHz.

FIG. 2 shows an embodiment of the present invention, where no filter units 12 and 13 are provided. Accordingly a deterioration of the signal processing is expected, in particular in the adaptive processor unit 15, because in this embodiment antialiasing effects must be expected.

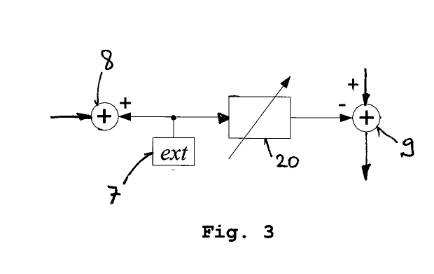

FIG. 3 shows a modified part of the block diagram shown in FIGS. 1 and 2. Thus, an adaptive delay unit 20 is contained in the signal path between the addition unit 8 and the subtraction unit 9 previous to its input in order to compensate a delay of the desired signal S. The delay of the desired signal S originates in the signal path via the addition unit 8, the digital-to-analog converter unit 2 and the analog-to-digital converter unit 3. The desired signal S, which is directly fed to the subtraction unit 9, must be delayed accordingly, in order to make an exact calculation of the error signal ε possible.

A flexible adjustment of the hardware of the present invention requires a digital implementation of the active noise reducing unit. As loudspeakers are present in such active noise reducing units anyway, an integration of other acoustic signals is desirable, like speech or music, for example.

As has already been pointed out, the signals detected, for example, by microphones are analog and must be converted for further processing with the adaptive processor unit into a digital format. CODEC's represent an efficient variation to this. They are low priced and optimized for audiovisual applications and have moreover several channels. A CODEC is run on all channels with identical sampling rate. As CODEC, the algorithms are suitable having the names TLV 320 AIC 23 or TLV 320 AIC 25 developed by the firm Texas Instruments Inc., for example. The present invention though is not limited to the use of these algorithms.

In principle the use of conventional converter units instead of CODEC's is feasible for each channel, whereby an individual sampling rate can then be adjusted for each channel.

The adjustment of the clock rates or the clock intervals, respectively, can be carried out in a digital signal processing unit (DSP—Digital Signal Processor), which is present in an embodiment of the device of the present invention for computing the adaptive process anyway.

Thereby, additional costs drop, which otherwise must be spent for the decimation units or the interpolation units, respectively.

1. Method for active noise cancelling in an input signal (I), which is fed to an unknown transfer function (H), the method comprising:
estimating the unknown transfer function (H) or its actual output signal (O), respectively, with the aid of an adaptive process by using the input signal (I) and an error signal (ε), the error signal (ε) corresponding to the difference between an estimated output signal (O*) and the actual output signal (O), and
subtracting the estimated output signal (O*) from the actual output signal (O) to form a noise reduced output signal (Q),
wherein a desired signal (S) is superimposed on the noise reduced output signal (Q), the desired signal (S) not affecting the error signal (ε), and wherein a computation cycle of the adaptive process is longer than a clock interval of the desired signal (S).

2. Method according to claim 1, including adjusting a clock interval of the input signal (I) to the computation cycle of the adaptive process and adjusting the clock interval of the estimated output signal (O*) to the clock interval of the desired signal (S).

3. Method according to claim 2, wherein the adjustment of the clock interval of the input signal (I) is carried out with the aid of a decimation algorithm.

4. Method according to claim 2, wherein the adjustment of the clock interval of the estimated output signal (O*) is carried out with the aid of an interpolation algorithm.

5. Method according to 4 claim 1, including correcting a time delay existing between the desired signal (S) and the noise reduced output signal (Q) with the aid of a delay unit (20).

6. Device to carry out the method according to claim 1 in which an input signal (I) is impinged on an unknown transfer function (H), resulting in an actual output signal (O), the device comprising:
an adaptive processor unit (15), to which the input signal (I) is impinged on and comprises an estimated output signal (O*),
means for generating an error signal (ε) from the estimated output signal (O*) and the actual output signal (O), and impinging the error signal on the adaptive processor unit,
means (14) for generating a noise reduced output signal (Q),
a desired signal source (7) for generating a desired signal (S),
means for superimposing the desired signal (S) on the noise reduced output signal (Q), and
wherein a computation cycle of the adaptive processor unit (15) is longer than a clock signal of the desired signal (S).

7. Device according to claim 6, further comprising:
means (4) for adjusting a sampling interval of the input signal (I) to the computation cycle of the adaptive process unit (15), and
means (5) for adjusting a sampling interval of the estimated output signal (O*) to a sampling interval of the desired signal (S).

8. Device according to claim 6, wherein the means (14) for generating a noise reduced output signal (Q) is at least one loudspeaker unit, to which the actual output signal (O) and the estimated output signal (O*) are impinged on.

9. Device according to claim 8, wherein the desired signal is additionally impinged on at least one loudspeaker unit.

10. Device according to claim 6, wherein the input signal (I) is impinged on a means (4) for adjusting a sampling interval of the input signal (I) to the computing cycle of the adaptive processor unit (15) via an analog-to-digital converter unit (1), and the estimated output signal (O*) is impinged on the means (14) for generating a noise reduced output signal (Q) via a digital-to-analog converter unit (2).

11. Device according to claim 7, further comprising a first filter unit (12) arranged previous to the means (4) for adjusting the sampling interval of the input unit (I) to the computation cycle of the adaptive processor unit (15).
